(19) United States
(12) Patent Application Publication
(10) Pub. No.: US 2006/0283269 A1
(43) Pub. Date: Dec. 21, 2006

(54) Fluid sampling components

(76) Inventors: Ian Anderson, Cambs (GB); Toby Trevor Fury Mottram, Cambridge (GB); John Gordon Richards, Bedford (GB); Peter Frederick Inskip, Bedfordshire (GB); Andrew Bradley, Bedford (GB); Peter Alan Richards, Bedford (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/560,532

(22) PCT Filed: Jun. 11, 2004
(86) PCT No.: PCT/GB04/02516

§ 371 Date: May 8, 2006

(30) Foreign Application Priority Data
Jun. 13, 2003 (GB) 0313759.3

(51) Int. Cl. G01N 1/20; A01J 5/007

(52) U.S. Cl. 73/863.31; 73/863.02; 119/14.18

(57) ABSTRACT

An animal product sampling device comprises a well arranged, in use, to collect fluid flowing through a fluid tube connected to the well, a drain, one end of which is connected to the well, which is arranged such that, in use, fluid from the well may pass to the fluid tube connected to the well, and a sample tube arranged, in use, to draw fluid from a zone of fluid of minimal turbulence within the well. The device is arranged such that, in use, the zone of fluid of minimal turbulence, from which a sample of fluid can be drawn through the sample tube, is created in the device due to the dimensions of the well and the drain. There is further provided an animal product sample transportation device and an animal product sample collecting device.

This invention relates to components for use in an apparatus for detecting and analysing biological agents in animal body fluids, for instance milk. More specifically, the present invention relates to a fluid-sampling device, fluid sample transportation means (temporary fluid storage means) and a fluid sample collecting device.

In recent times it has been realised that there is a benefit in monitoring collected animal body fluids, such as milk from dairy cattle, for the presence of certain chemicals such as hormones. For example, it can be beneficial to monitor the milk of a cow to detect the presence and level of progesterone in order to determine its ovulating cycle. Alternatively, there may be a need to monitor the milk to detect for other types of bio-markers, such as chemical imbalances that are indicative of a disease in the cow or other animal.

Monitoring collected animal body fluids for the presence and concentration of hormones, and in particular progesterone, is known. By frequent analysis of progesterone levels in milk samples from a particular animal, ovulation cycles can be mapped and can be used to detect ovarian dysfunction. Similarly monitoring of luteinising hormone levels in milk samples gives another method for mapping an animal's ovulation cycle.

Examples of other types of bio-markers that are known to benefit from monitoring, include: NAGase activity, which can indicate that an animal is stressed or suffering from sub-clinical mastitis; ketone levels, which indicates whether an animal may have ketosis; corticosteroids, which indicate stress levels; and antibiotics or other medical compounds. Bio-markers can also indicate response to the presence of a disease, for example bovine viral diarrhoea virus (BVDV) or Leptosporosis (Weil's disease). Detection of disease vectors can lead to early treatment of the disease and the prevention of spread of infectious diseases to other animals. As a further example, milk and cells contained within it may be analysed for genetic properties.

Sampling of farm animals and measurement of these bio-markers by specialists (in particular veterinarians) on the farm, within veterinary practices and within analytical laboratories is typically expensive and time-consuming.

Specialist knowledge and expertise is needed: to identify from which animals to sample and measure the bio-marker; to take a sample of body fluid; to undertake the assay to measure the bio-marker; and to process the results of the assay and suggest appropriate action.

The farm environment presents additional problems. Testing on farm premises has been seen as unfeasible due to the difficulty of achieving satisfactory precision and because of the time the farmer can afford to spend performing the tests manually. Prior art testing apparatus is large, awkward and expensive or limited to robotic milking or appropriate only for scientific research.

There has been a considerable amount of research and development in terms of automating animal milk collection. Systems which gather milk automatically and then monitor for the presence of bio-markers (biological or chemical agents) in an automatic manner have been produced, however these systems have various disadvantages which affect the efficiency of the sampling and the extent to which analysis can be performed.

In known milking systems, samples are taken, for example, by opening a valve in the milk line of each cow for a predetermined time. This sample milk can then drop (via gravity) onto analysing means or can be passed along tubes to a separate component which stores the milk samples for later analysis off line. Commercially available systems require human intervention to identify, transfer and label sample pots.

In prior art sample analysis systems the assays of interest have been predetermined by the design of the system and have a fixed sampling regime which cannot be adapted at will. There is no provision of a sample ordering system which keeps track of specific samples so that they may only be directed for analysis of selected assays. In prior art systems, the samples are analysed generically and there is no way of specifying or altering the path of the samples. If one or some of the animals are suspected of having a certain disease or deficiency, there is no way of analysing the samples of these animals immediately and then deciding whether or not to test other animals depending on the results of these tests.

The present invention seeks to provide an apparatus in which certain components help to overcome or at least ameliorate some of the current problems associated with the monitoring of milk collected from animals such as dairy cattle.

In accordance with the present invention there is provided an animal product sampling device comprising:

a well arranged, in use, to collect fluid flowing through a fluid tube connected to the well;

a drain, one end of which is connected to the well, which is arranged such that, in use, fluid from the well may pass to the fluid tube connected to the well; and

a sample tube arranged, in use, to draw fluid from zone of fluid of reduced turbulence within the well,

wherein the device is arranged such that, in use, the zone of fluid of reduced turbulence, from which a sample of fluid can be drawn through the sample tube, is created in the device due to the dimensions of the well and the drain.

Also in accordance with the present invention there is provided an animal product sample transportation device, the transportation device comprising:

a plurality of tubes of equal diameter, through each of which a sample of fluid passes in use;

varying means arranged, in use, to vary the speed and flow of discharge from the tubes; and

evacuating means arranged, in use, to evacuate the tubes to minimise the quantity of residual fluid.

The device can also include control means arranged, in use, to control the flow in the tubes such that each tube can controllably retain a sample temporarily, and can include determining means arranged, in use, to determine the presence of fluid in each tube at the point where it is discharged from the tube.

The device can also include washing means arranged, in use, to wash the tubes and remove surplus wash material.

Furthermore, in accordance with the present invention there is provided an animal product sample collecting device, the device comprising:

a moveable frame, supporting, in use, a plurality of chambers arranged to collect, in use, animal product samples, the frame being positioned, in use, to accept, in the chambers, samples from an outlet of a sample selecting device; and

a frame driver for moving the frame relative to the outlet in order to allow the samples to be dispensed into the chambers.

The chambers may constitute removable collection vials.

The movable frame may be a rotatable carousel, and may contain removable inserts in which the vials are housed.

The invention provides a generic collection, sampling and ordering mechanism which can then be fed into a plurality of analytical devices. The sampling components and analytical devices are connected, but act independently so that sampling and analysis can be separated, if required, temporally or spatially.

The present invention provides a sampling regime whereby samples can be taken from selected cows and selected assays can be performed according to the requirements of the farmer and/or the economic value of the cow and/or previous analyses from the selected cow. Although the analysis of some assays must be conducted by an automated regime at fixed times, the sampling regime may also be adjustable so that the system can take and analyse a sample of milk from a selected cow when the milking machine operator demands it. By monitoring internal data which maps the progress of a disease or the ovulation cycle, the timing of the assays may be adapted according to this previous sample data. Furthermore, by providing an adjustable sampling regime, the sensitivity of the system can be altered by the farmer or an off-site data analyst (either human or software-based) as required.

By providing a well, a drain and a sample tube at each sample point and by balancing the dimensions of these parts of the sample point, a zone of milk of reduced turbulence is created, thereby eradicating bubbles in the sample which is drawn through the sample tubes. If these tubes are of a fixed length this ensures all of the samples taken are of an equal volume. The tubes act as temporary storage means for the samples, and there is no need for a separate intermediate storage component. Furthermore, these tubes can be bundled together in order to decrease the overall size of the milking apparatus and reduce heat loss.

By controlling the exposure of certain analysers to specified samples, much of the inconvenience of conventional monitoring systems can be avoided.

The collector can store a number of samples in sequence and then direct them to specific analysers according to instructions from a controlling processing system. These instructions may be automated, adapted due to historical data or adapted at will by the farmer or another system operator. The collector therefore provides flexibility within the sampling regime. The provision of this component also enables the system to provide multiple analyses from each milk sample or each cow as required.

Each bio-marker is tested for in a separate analyser, in which the biosensor, or alternative means for performing the assay, is housed. The analysers may use any other form of sensing technique, such as solid phase immunosensors or optical field analysis, and may or may not operate simultaneously. As will be described later, the milk samples can then be diverted to specific analysers depending on which assays are required. This ensures that the samples are properly separated and are not wasted on any unnecessary assays. It is not necessary, therefore, to analyse for all conditions simultaneously. Additionally, as groups of biosensors or similar devices need not be manufactured prior to milking, the sampling regime may be adapted to include or omit certain assays at will. This provides a superior and more efficient analysing regime. For example, disease assay is necessary perhaps only once a year or during the outbreak of an infectious disease, while progesterone must be routinely analysed in perhaps less than 5% of milkings, and mastitis must be tested for at frequent intervals. By providing a separate analyser for each assay, samples may be directed to these easily and quickly for analysis.

The present invention will now be described with reference to the accompanying drawings, in which:

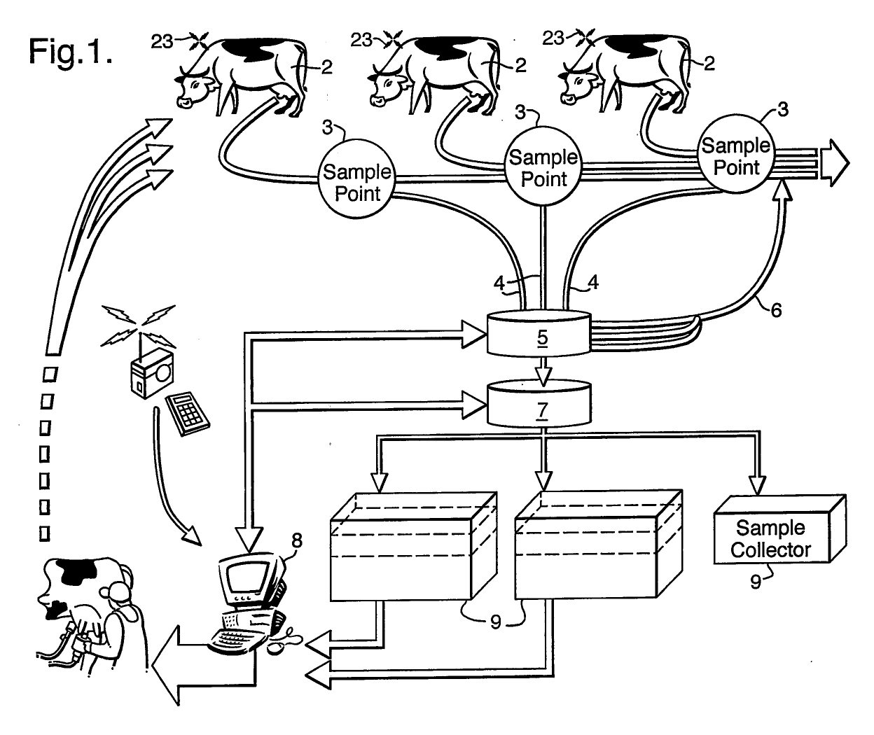

FIG. 1 shows a milking apparatus according to the present invention;

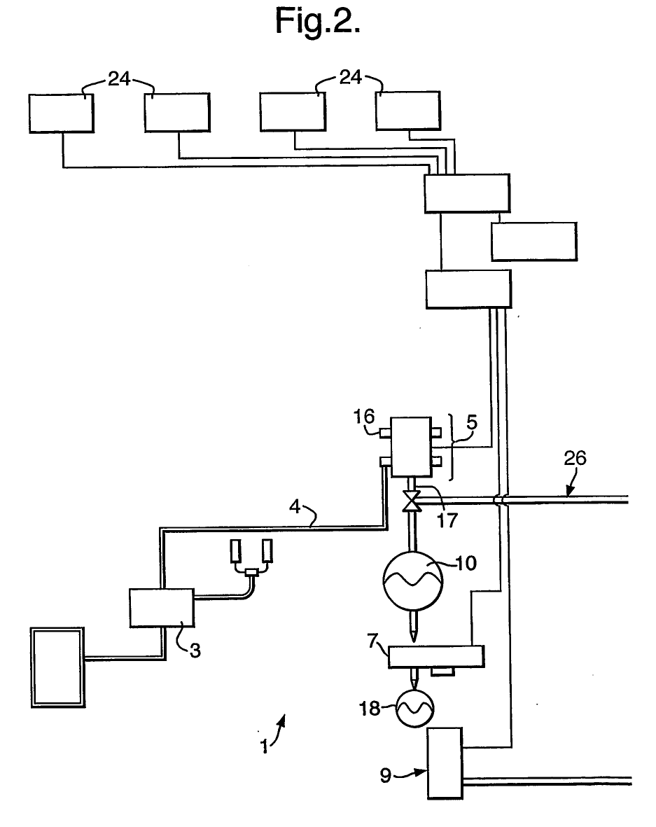

FIG. 2 shows the workings of the apparatus of FIG. 1 in greater detail;

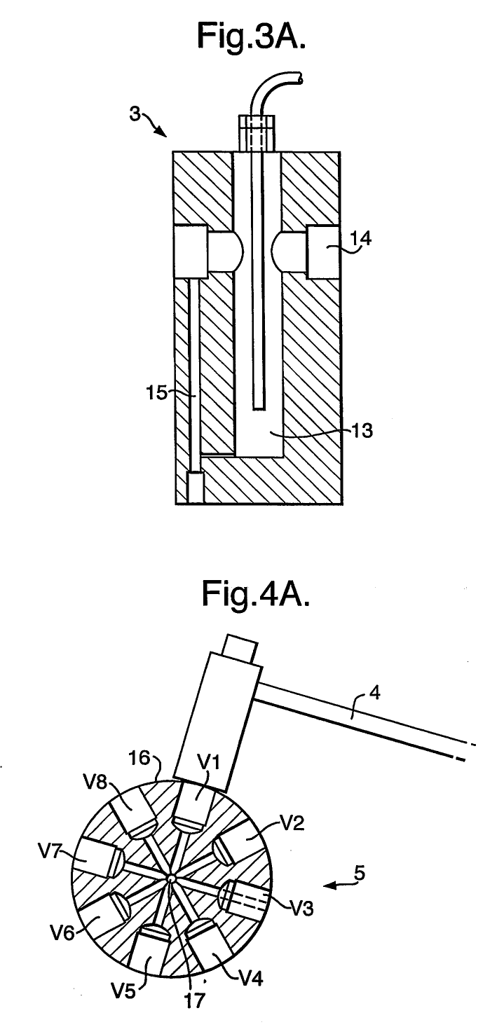

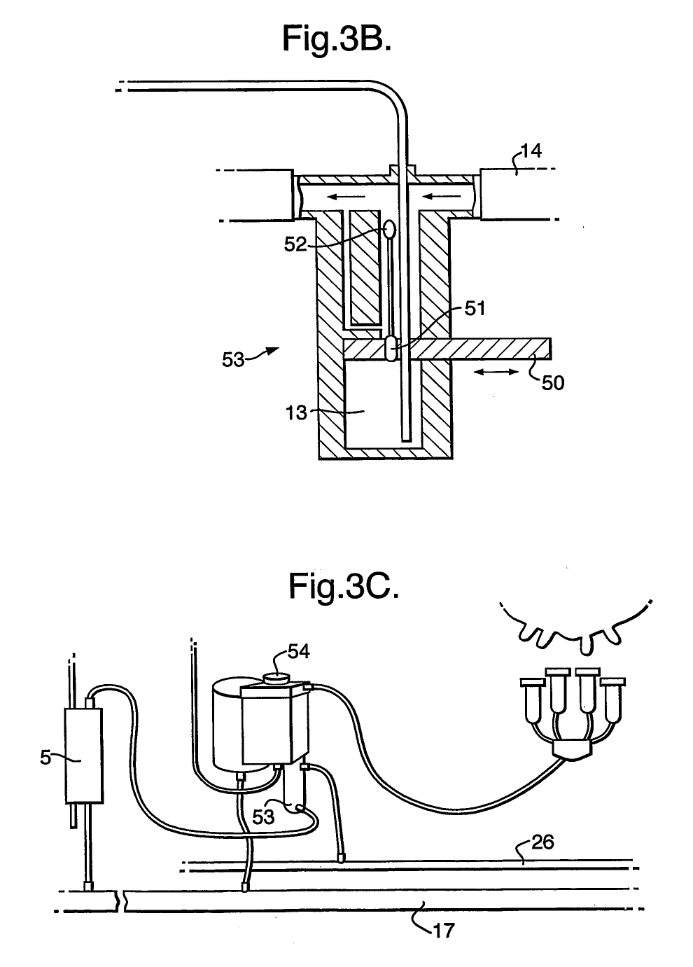

FIG. 3A illustrates a sample point which is used in the apparatus of FIGS. 1 and 2;

FIG. 3B shows proportional sampling means which are integrated into the sample point of FIG. 3A;

FIG. 3C shows how a proportional sample point can be integrated into a standard milk meter;

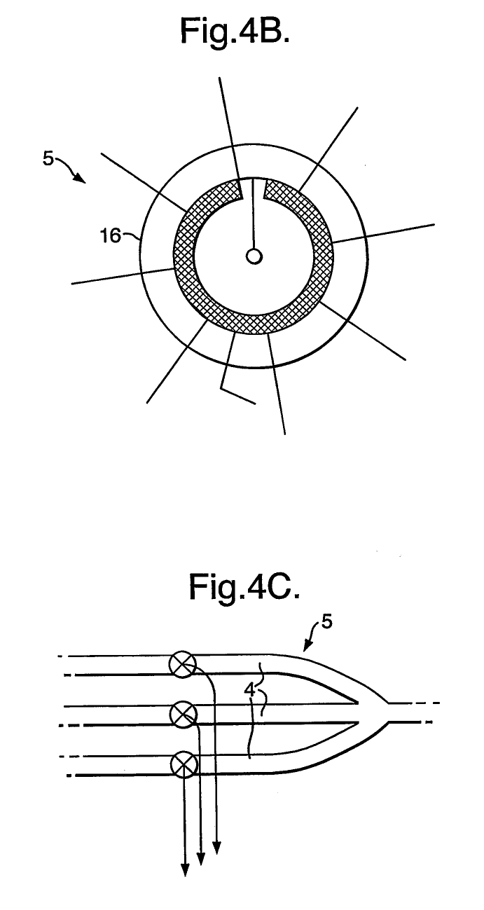

FIG. 4 illustrates a sampler which is incorporated into the apparatus of FIGS. 1 and 2;

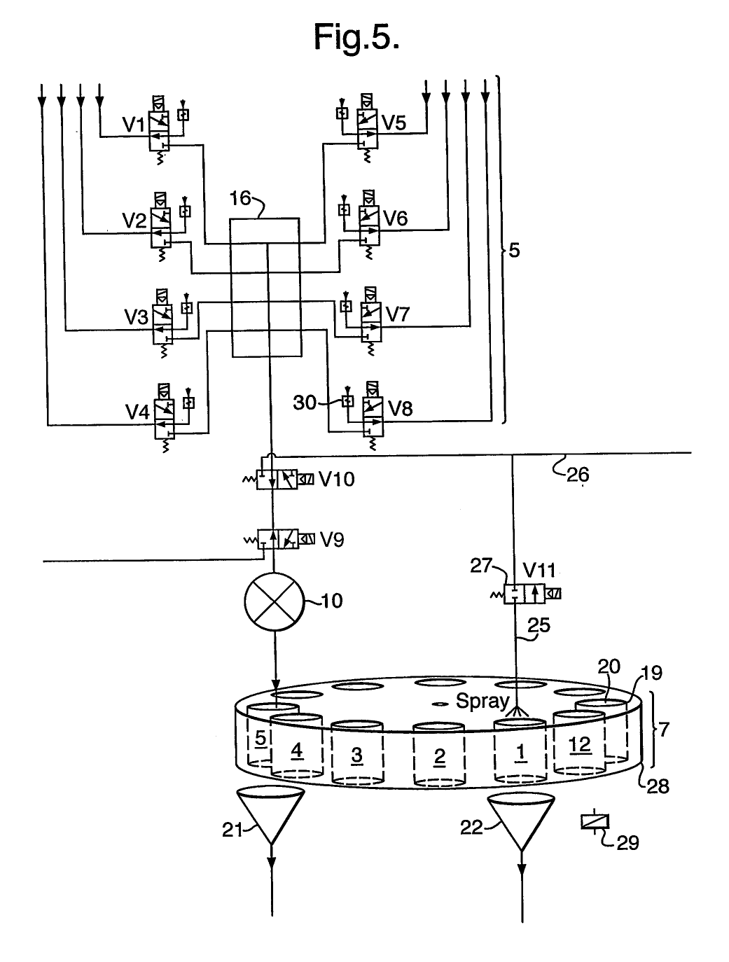

FIG. 5 shows the sampler and collector of FIG. 2;

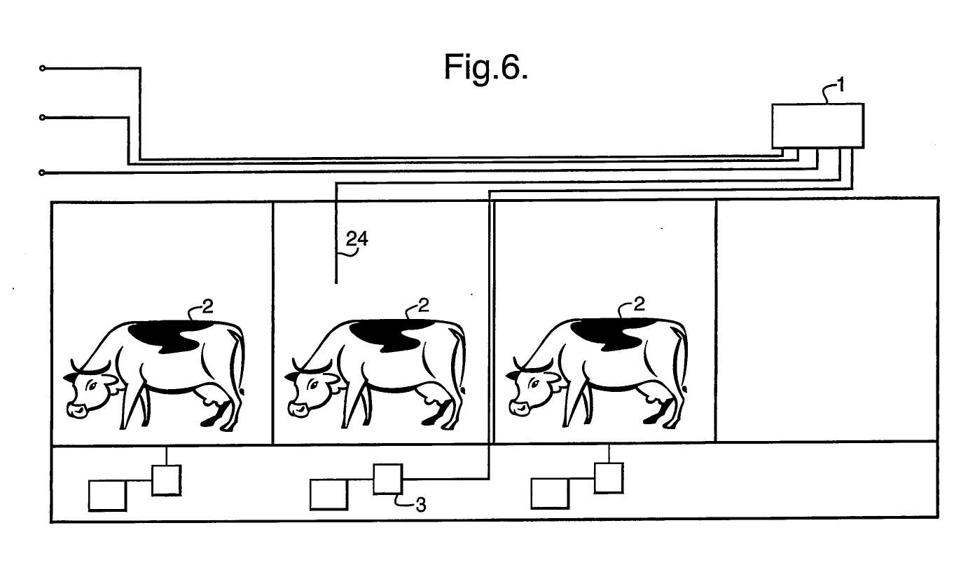

FIG. 6 shows an identification device which is incorporated into the apparatus of FIGS. 1 and 2; and

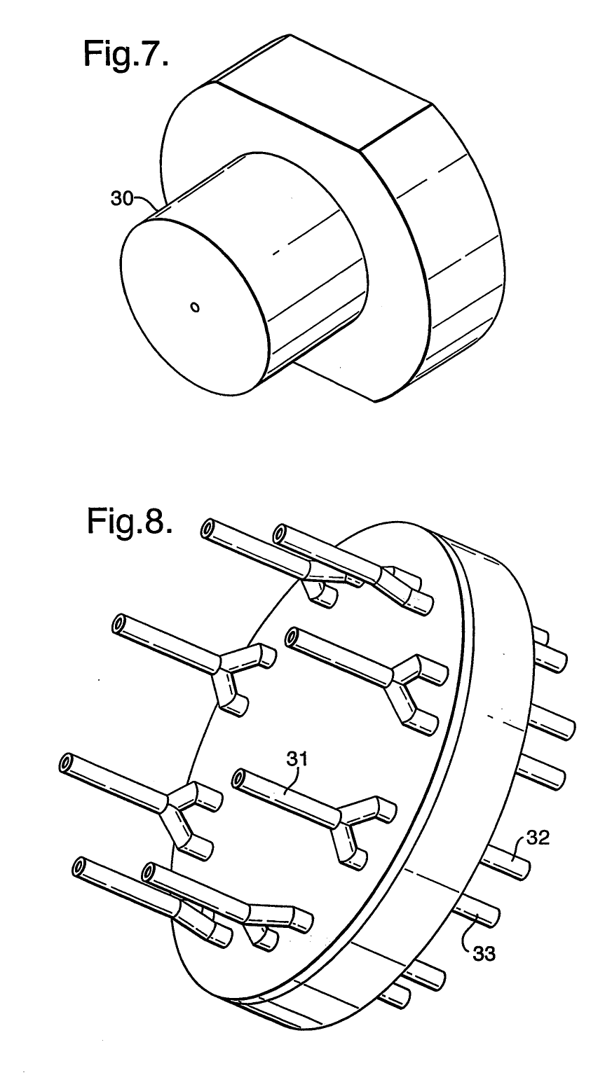

FIG. 7 shows a bleed valve which is incorporated in valves V1 to V8 of FIG. 4 and FIG. 5;

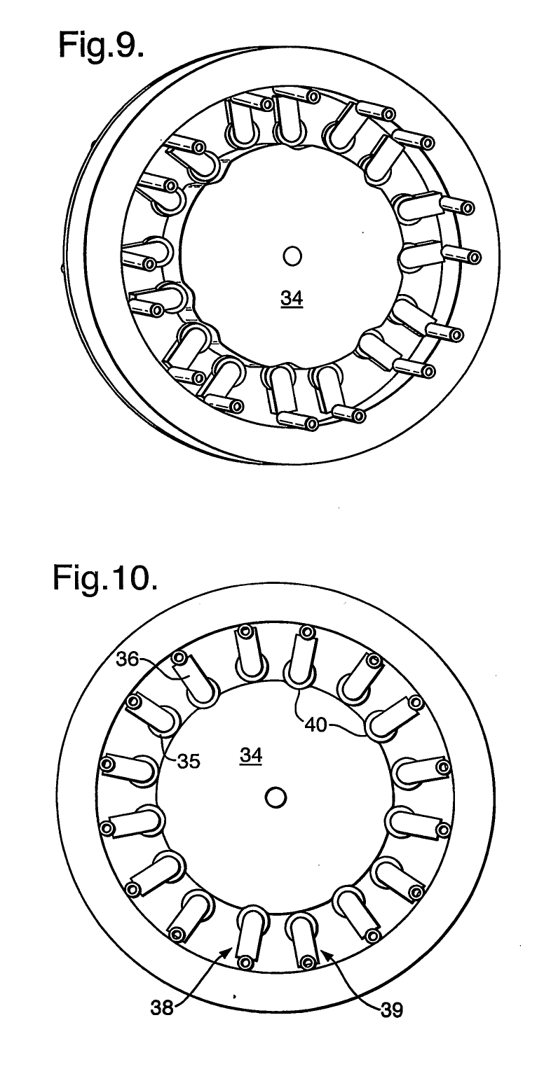

FIGS. 8 to 10 show an example of a multi-way rotary sampling valve which is incorporated into the apparatus of FIGS. 1 and 2.

Although an apparatus in accordance with the present invention may be adapted to analyse samples from a number of different farm animals within a number of different body fluids, the invention will be described by way of illustration with respect to performing assays within the milk of dairy cows during milking within a milking parlour.

FIG. 1 shows how the use of multiple analysers is implemented within a milking apparatus, and how certain components interact to allow for the samples to be taken, selected for analysis and directed to the correct analysers in a fixed or adaptive manner. The analysers do not necessarily operate simultaneously.

Referring to FIG. 1, the milking apparatus 1 is provided with sample points 3, which take samples from the milk produced by each cow 2. The samples are directed to a sampler 5 through sample tubes 4, and are then passed to a collector 7. In an alternative configuration the samples are directed to a sampler 5 through sample tubes 4, and are then either returned to the main milk line through the optional milk return line 6 or selected for analysis and passed to a collector 7. The samples can then be directed to analysers 9 depending on instructions from a herd management database 8.

The processing system, for example a computer or a microprocessor device, has a memory unit, the memory unit storing: a database of information on individual animals; a plurality of mathematical models of bio-marker properties; and interface software, for interfacing with the sampler 5, the collector 7 and the plurality of analysers 9. Current implementations of the processing system include embedded PCs and PC104 expansion cards. The operating system used may be any convenient OS, for example DOS, MS Windows, UNIX/Linux, Apple, Symbian EPOC or PalmOS.

The processing system is programmed to receive and update information held on the animal database. Examples of the information held on the database include: age, calving information, and results of previous analysis. The processing system is also programmed to use the mathematical models to relate the measured concentration of specified bio-markers to fertility, wellness or disease status.

Information can be passed from the herd management database 8 to the sampler 5 and collector 7. The system also provides a manual “over-ride” option, the form of a button, for example, which allows the farmer to check the fertility (confirmation of insemination day) or disease status of a specific animal.

FIG. 2 shows the workings of the apparatus in greater detail. Once the animal comes into the stall to be milked it is identified, a cluster is attached to the cow and milking can begin. The system is monitored so that, at a specific point after attachment or once a set volume of milk has been collected, sampling can begin.

FIG. 1 shows how a milk sample is drawn from the milk tube into the sampler, collector and analyser using positive pressure. FIG. 1 shows how, in an alternative example of an apparatus, a small proportion of the milk from each milk line is passively diverted and flows in a parallel system to the main milk flow. This milk, by default, is returned back to the system, either to each individual milk line or to a receiver vessel. The diverted milk tubes pass through a sampler 5 which is capable of taking samples from an individual milk tube when instructed. This system allows a small aliquot of milk to be taken from any animal when required with minimum milk loss.

Milk is therefore either generically sampled and returned to the milk line when it is not selected to move on to the analysers (passive sampling), or alternatively only certain lines are sampled (active sampling). These options mean that milk which is not specifically used for an assay is not wasted. This is essential when analyses are frequent, as the cost of the lost milk may outweigh that of the analysis.

As an additional feature when deciding upon a sampling regime in a group of animals the sampling apparatus may include a means of performing an initial assay on a bulk sample of fluid. In the case of, for example, a herd of cows, this group sampling is integrated into an existing milking apparatus by connecting one or more of the sample lines to, for example, a milk sample line, milk transfer line, milk collector or bulk tank within the apparatus. A sample is taken from every cow or a subset of cows in the herd and the samples are collected together to form a bulk sample. An initial assay is then performed on the bulk sample in order to determine whether a problem exists somewhere within the herd. If the initial assay does indicate that, for example, a certain disease is present in the bulk sample, and is therefore present in one or more cows within the herd, individual sampling can then be adopted on this basis. Such a feature clearly saves a great deal of time and has economical benefits over sampling each animal individually to determine whether a problem exists initially.

The sample points 3 of the apparatus may be positioned before or after, or integrated into, any device in the milk line, for example it may be integrated into a milk meter of the milking system. An example of a sample point is shown in FIG. 3A. This may be a reusable device or a disposable one, in which case the sample point is cheaper to manufacture servicing and fault finding are simplified.

The sample point 3 is based on a well 13 set in the long milk tube 14 with a drain 15 which returns milk and wash water downstream. The sample is drawn through a tube suspended from the top of the well 13. The correct balance of depth of well 13 and size of drain 15 creates a zone of milk of reduced turbulence for drawing a sample which is as free of bubbles as possible. Depending on the set-up of the sample point 3, the device can be attached at an angle of between 0° and 90° to the vertical. The sample tube could also enter from below. The internal diameter of the sample tube is preferably between 1 mm and 15 mm. The device may further include a controlled valve or a non-return valve, in order to ensure efficient sampling, if required. A self-draining valve may be positioned in the sample point below the long milk tube 14; this feature can be employed to prevent blockage and as a mastitis clot detector.

The sample point 3 can also act as a proportional sample point 53, by integrating a valve into the device such that a continuous sample is slowly collected througout milking.

FIG. 3B shows an example of the way in which proportional sampling means could be integrated into the sample point 3. As shown, a slider 50 with a built-in proportional valve 51 can be employed in order to allow a user to switch, either automatically or manually, from a position that allows sampling during milking, to a position that blocks the valve once milk sampling has finished or is no longer required. During such proportional sampling, a bistable valve 52 is periodically triggered by the flow of the milk, thus opening and closing the proportional sampler valve 51. The milk collected by the proportional sample point 53 can then be transported, either periodically or once sampling has been completed, through a sample line which draws from the base of the proportional sample point.

The proportional sample point can also be integrated into a standard milk meter 54 (for example, the “Flomaster 2000”), as shown in FIG. 3C. The proportional sample point 53 is also connected to a wash line 26, and milk sample line 17. An automatic sampler 5 (described later) links the proportional sample point 53 and milk sample line 17, and a wash system can run through the automatic sampler. Sampling milk is returned to the milk sample line 17.

Proportional sampling is advantageous when monitoring for certain conditions. Fat levels, for example, are variable throughout milking; by consistently and regularly collecting milk from the milk line, an average level can be found, thereby giving a more accurate result. Alternatively, this proportional sampling device could be detachable, such that it is simply incorporated into the sample point depending on which assay is to be performed.

The detection of infections, such as mastitis, can also be performed at the sample point 3 by measuring the conductivity or other ionic phenomena of the sample. By providing two or more electrodes which are brought into contact with a sample, the conductivity can be quickly and simply detected and the data analysed for infection.

Once each of the required samples has been taken it is passed to the sampler 5 via a tube 4. In the favoured method these tubes 4 may be of any length. In the alternative method these tubes 4 may be of the same length or a known length, and may be used for temporarily storing milk samples of a known volume before they pass to the sampler 5. In prior art systems, the tubes differ in length depending on where the sample point and sampler are located within the milking apparatus, and are used as a transportation means only, such systems therefore require additional temporary storage means. The fixed, known length tubes 4 of the apparatus 1, however, act as a temporary storage device, as tubes which are of a known length may store a known volume of sample. The tubes 4 are preferably also between 1 mm and 15 mm in diameter each, and may be lagged or bundled together and insulated to prevent significant heat loss.

FIG. 4 shows examples of samplers. The sampler 5 receives samples from the sample points 3 and then directs these, depending on controller instructions, to the collector 7. FIGS. 4A and 4B show a sampler 5 to which all the milk samples flow (or are pumped) through their respective tubes 4. The samples may flow into a manifold 16 and then together into a single milk sample line 17. It is important that this line is large enough to allow enough wash water to pass through bleed valves V1 to V8 simultaneously. These valves will be described in detail later with reference to FIG. 7. The valves and sample lines may also, however, be washed selectively. A rotating valve system may also be employed, so that some or all of the milk samples flow together and by default flow into a single tube which goes back to the milking system or to waste. A multi-way rotary sampling valve, which can be employed as an alternative system to the use of valves V1 to V8, will be discussed in greater detail later with reference to FIG. 8. Alternatively, as shown in FIG. 4C, the tubes 4 along which the milk passes after it has been collected at the sample point 3 can each have a diverting valve which allows a small quantity of milk to be taken if required. Samples which are selected for analysis are then passed to a collector 7 via a peristaltic pump 10, as shown in FIG. 2. Pump 10 acts as a vacuum pump, and can be a venturi system, which creates a higher vacuum in order to pump the milk as efficiently as possible.

Milk passing from pump 10 can pass through a flow sensor (not shown), which is positioned to monitor the flow of the milk in order that the parameters such as flow rate can be adjusted at will or as required. This feature is particularly important when switching between the sample collecting and washing regimes. For example, when a new milk sample is to be processed, the flow rate of the new milk is initially increased in order to flush the equipment with the new milk—this will help to minimise the risk of cross-contamination of any samples taken from the new milk. Once flushing is completed, the flow rate may be decreased to a suitable rate for sampling to commence.

An example of a collector, to which the selected samples are directed, is shown in FIG. 5. The device has a number of chambers that contain inserts 19, which in turn each hold a collection vial 20. The collector 7 collects a number of samples in vials 20 (as instructed), and each insert 19 within the collector 7 can be removed, either individually or within a carousel, for processing, analysis or storage. The inserts are temperature controlled to ensure accuracy of measurement. The carousel 28 is driven by a motor (not shown). The collector 7 can therefore store a number of samples in sequence until the analyser 9 is ready to conduct the required assay. Each collection vial 20 is indexed, and the system is able to store a record of what sample is within each. Additionally, the vials 20 may contain a means of agitating the milk in the base thereof; this may take the form of a magnetic stirrer, sonification means or a physical stirrer. An array of electrodes can also be mounted in the collector 7 to determine the electrochemical properties of the milk in the sample. Once the collector 7 receives instructions on how to proceed with a specific sample, a motor or solenoid operated depression valve 29 is activated to allow the sample to be passed to an analyser or to waste. The sample may be removed by gravity or by a pump 18 (see FIG. 2).

The use of a collector enables the system to perform multiple analyses from each milk sample or each cow. For example, multiple samples may be taken from the same vial and routed to separate analysers via a diversion valve. Alternatively, cones 21 and/or 22 positioned under the collector may receive the samples from certain vials as desired. These cones may be for use with a specific analyser, or a single cone with separate sections could be used to sub-divide a single sample into sub-samples. The use of a cone allows multiple samples to be taken from a specific cow.

The combination of a single sampler and a collector for multiple sample points uses electrical apparatus which is far simpler than that of prior art. The complexity, cost, size and restraints on location of this portion of the apparatus is therefore reduced.

The analysers to which the selected samples are sent conduct a chemical, biochemical or physical assay to measure one or more bio-marker. For this purpose each analyser can include a reaction chamber, where the assay may be carried out. The data output from the assay is communicated to the herd management processing system.

The analysers transmit information to the processing system to enable rapid and timely analysis of samples. This information will include the time before readiness to analyse, the type of analysis that it will conduct, the volume of sample it requires, the timing of sampling during milking, the type and number of the remaining sensors, the need for servicing and other information for it to operate.

Depending upon the particular assay to be performed, a biosensitive region (or biosensor) within the analyser may include one or more key elements required to measure a bio-marker, for instance assay solutions, electrodes (often made of carbon), or fixed antibodies.

Examples of appropriate testing techniques include chemical, biochemical and immuno-assay. As an alternative reagents may also be incorporated into the analyser itself. The reagents and the biosensors used typically have an operative range of temperatures. The analyser may further be provided with a temperature control mechanism (not shown) for maintaining its temperature at a specified level or within a predetermined range.

Details of measurements corresponding to each given animal are transmitted to an animal database. In a fully automated system, the test measurements are transmitted electronically as data signals for storage in a computer database.

The incorporation of antibodies (either deposited on the bio-sensitive region or in free solution) allows a specific immunoassay to take place within the reaction chamber and for a specific bio-marker to be measured. In certain cases, the bio-sensor measurement device includes a control reaction chamber in which measurements from a bio-sensor (in the absence of one component of the assay) will be used to remove a substantial proportion of any background signal from the milk.

Some assays do not require a bio-sensor (or use a bio-sensor but require no antibodies) and will measure a bio-marker directly in the milk utilising a chemical or physical reaction. Examples of such assays include: an enzymatic reaction catalysed by an enzyme in the milk; or a specific wavelength of the electromagnetic spectrum correlating to the concentration of a known bio-markers.

Preferably, the automated sample processing arrangement includes a cow identification device, which identifies which cow is being milked and in which stall the cow is being milked. Identification data may be gathered automatically. An example of such a device and how it can be applied to the milking apparatus are shown in FIGS. 6 and 2, respectively. Each animal is fitted with a transponder 23 (see FIG. 1) whose signal is received by an antenna 24 in its respective stall, and this antenna 24 is coupled to the identification device via cables. A multiplexer gathers the signals so that they can be transferred to the processing system simultaneously. Alternatively the data may be gathered manually, for instance through data entry into a mobile terminal device with a communication link to the herd management processing device or through a conventional computer keyboard plugged into the herd management processing system. The identification device will therefore communicate directly or indirectly with the herd management system.

The cow identification device gathers cow identification information (whether manually or automatically) thereby recognising which cow is being milked and in which milking stall.

Cow identification information is transferred to the herd management processing system, which accesses the cow database to retrieve data relating to the identified cow and the mathematical models for specified bio-marker properties. The processing system then analyses: information on the cow; parameters set by the is farmer; the models of specified bio-markers; measurement regimes and other information. Next the processing system determines whether a sample of milk from that cow should be used for measuring one or more bio-marker.

The sample point takes a sample of milk from the milk line while the, now identified, cow is being milked. This sampling may occur for all cows or for only specified cows. As described above, the sample from each of the sample points is directed to the sampler.

FIG. 7 shows a continuous flow (or bleed) valve 30 that is inserted in the normally open path of valves V1 to V8, that are a part of the sampler 5. When no sample is being taken this device clears the sample tube of any residual milk by drawing air. The diameter of the holes are optimised to ensure that air ingress from the multiplicity of sampling points does not reduce the vacuum reserve below that specified in ISO 5707.

The bleed valves V1 to VB may be 5-port/3-position valves. The flow of milk or wash fluid through the system can be controlled by systematically opening and closing the valves during washing or between samples. For example, by closing bleed valves V1 to V8 during washing, wells 13 can be emptied.

FIGS. 8 to 10 show an example of a multi-way rotary sampling valve which can be employed as an alternative system to the valve system of FIGS. 4A and 4B.

Each valve (eight are shown, although this number is variable) has three pipes or sample tubes. Sample tube 31 connects to the pump via a manifold, sample tube 32 connects to the sample point and sample tube 33 connects to a bleed through hole. The valves are arranged in a rotary fashion so each one of the eight can be selected in turn. A motor drives a rotary cam 34 which has cut outs 40 which engage with selection wheels 35 of sample tube 32. Selection wheels 35 in turn move sample tube selection bars 36. If a cut out in the cam 34 aligns with a wheel 35 the tube selection bar 36 is pressed away from the tube by a spring (not shown); this opens the tube and liquid (or air) can travel down it (as indicated by reference numeral 38). If the cut out is not aligned with a wheel the tube selection bar closes the tube and there is no flow (as indicated by reference numeral 39). The cut outs in the cam 34 are arranged so that there is only ever one sample tube open per valve at any one time.

The multi-way rotary sampling valve described above enables sampling from various points, and the points can be selected as required—if a point is not selected for sampling then it is connected to the bleed through hole in order to clear the pipe. This system is advantageous as the internal workings of the valve consist only of a straight piece of pipe, and it is therefore easy to keep the valves clean.

Depending upon the instructions received from the herd management processing system, the sampler 5 directs the samples to either, waste a specific analyser, a temporary or long term storage device.

When samples are directed to the analyser, it conducts a chemical, biochemical or physical assay and measures a specific bio-marker in that milk sample. The herd management processing system determines which assay or assays are to be conducted and hence which analyser the sample is directed to. The data output of the assay will be communicated to the herd management processing system.

The herd management processing system will then process the results of the assay, using the embedded mathematical models of specified bio-markers and stored animal data relating to that specific cow. The processing system is preferably programmed to present a graphical user interface to allow the farmer to access the acquired information and ultimately to assess the status of his herd. If any urgent actions are required, the processing system is advantageously programmed to alert the operator and to suggest what action may be required, for example; “cow A3 (currently in stall 5) is ovulating, contact the AI (artificial insemination) professional within 24 hours”, or “cow F5 is not ovulating as normal, contact the veterinarian”. In this case, the milk of other cows which may be affected (for example in the case of a disease), can be sampled and analysed quickly, accurately and on demand.

The processing system may furthermore be in communication with wireless and/or wire networks of computing devices. The processing system can then generate and send text messages directly to a wireless communicator device (for instance, a mobile telephone or a personal communication device) to report the status of an individual cow or of the whole herd. Likewise processing system can send a request for action directly to a third party (for example an email message to a veterinarian or an AI professional).

As might be expected, the processing system is preferably programmed to be able to change the sensitivity and frequency of measurements of any given bio-marker. The software running on the processing system is preferably capable of learning and adapting to the requirements of each individual cow.

By providing an integrated, hygienic wash system, which is co-ordinated with conventional milking machine wash cycles, the sample points 3, tubes 4, the sampler 5, the collector 7 and the analysers 9 can be washed out between milk sampling and/or at the completion of the milking of the herd.

The tubes 4 between the sample point 3 and the sampler 5 are washed by sensing when the milk machine is being washed, either through integration with the milk machine control system or by employing a vacuum sensor or other sensor. A small amount of washing fluid from the milk line is then drawn through the tubes 4 and sampler 5 automatically during the circulation cleaning of the entire milking apparatus. Alternatively, a wash line is inserted at each sample point 3.

A three-way valve and wash line is inserted between the sampler 5 and collector 7 of the second milking apparatus, in order to wash these components. This provides an option as to which of the two components is washed. By providing a wash tube 25 above one of the collection vials 20 which is capable of spraying wash fluid at an angle, a “swirling” effect is produced which effectively cleans the vial 20 and the cones 22. Washing fluid can enter and exit the sampler 5 or collector 7 via an internal wash line 26. The pump 10, its inlet and outlet and cone 21 are cleaned between samples by opening valves V9 and V10 when no vial is present in the position above cone 21. In the case of the collector 7, a valve 27 can control access of the washing fluid to the vials in order to protect against contamination of the milk from the washing fluid. Furthermore, each analyser 9 has its own wash system. By giving each component of the apparatus 1 its own wash system in this way, the parts of the device may be washed individually as needed or desired.

Each analyser's wash system, which is separate to that of the collector 7, as the analyser runs in parallel to the milking process and may not therefore be ready for cleaning at the same time as the rest of the apparatus: milking may finish before or after the analysis cycle.

Once washing of a component or set of components has been completed, the used washing fluid is discharged to waste. If every cow is to be sampled passively, for example in the case of testing for mastitis, then the whole sample tube will not have to be filled with milk and the last sample will have to be drawn through using water from the wash cycle. This will reduce the cost per sample. In the favoured active method milk loss is minimised.

1. An animal product sampling device comprising:
a well arranged, in use, to collect fluid flowing through a fluid tube connected to the well;
a drain, one end of which is connected to the well, which is arranged such that, in use, fluid from the well may pass to the fluid tube connected to the well; and
a sample tube arranged, in use, to draw fluid from a zone of fluid of reduced turbulence within the well,
wherein the device is arranged such that, in use, the zone of fluid of reduced turbulence, from which a sample of fluid can be drawn through the sample tube, is created in the device due to the dimensions of the well and the drain.

2. A sampling device according to claim 1, wherein the sampling device is integrated into a milking apparatus.

3. A sampling device according to claim 1, wherein the device is disposable.

4. A sampling device according to claim 1, wherein the device further comprises a self-draining valve.

5. A sampling device according to claim 1, wherein the device includes a filter therein.

6. A sampling device according to claim 1, the device further comprising a proportional sampling device such that, in use, a sample is continually taken.

7. A sampling device according to claim 6, wherein the proportional sampling device is detachable from the sampling device.

8. A sampling device according to claim 1, the device further comprising two or more electrodes that contact the fluid being sampled in use, in order to measure ionic phenomena of the fluid.

9. An animal product sample transportation device, the transportation device comprising:
a plurality of tubes of equal diameter, through each of which a sample of fluid passes in use;
varying means arranged, in use, to vary the speed and flow of discharge from the tubes; and
evacuating means arranged, in use, to evacuate the tubes to minimise the quantity of residual fluid.

10. An animal product sample transportation device according to claim 9, the device further comprising control means arranged, in use, to control the flow in the tubes such that each tube can controllably retain a sample temporarily.

11. An animal product sample transportation device according to claim 9, the device further comprising determining means arranged, in use, to determine the presence of fluid in each tube at the point where it is discharged from the tube.

12. An animal product sample transportation device according to claim 9, the device further comprising washing means arranged, in use, to wash the tubes and remove surplus wash material.

13. An animal product sample transportation device according to claim 9, wherein the plurality of tubes vary in length.

14. An animal product sample transportation device according to claim 9, wherein the tubes are of a known length.

15. An animal product sample transportation device according to claim 10, wherein the control means are bleed valves.

16. An animal product sample transportation device according to claim 10, wherein the control means are multi-way valves.

17. An animal product sample collecting device, the device comprising:
a moveable frame, supporting, in use, a plurality of chambers arranged to collect, in use, animal product samples, the frame being positioned, in use, to accept, in the chambers, samples from an outlet of a sample selecting device; and
a frame driver from moving the frame relative to the outlet in order to allow the samples to be dispensed into the chambers.

18. A collecting device according to claim 17, wherein the chambers comprise removable collection vials.

19. A collecting device according to claim 17, wherein the movable frame is a rotatable carousel.

20. A collecting device according to claim 18, the device further comprising removable inserts in which the vials are housed.

21. A collection device according to claim 17, wherein the chambers are temperature controlled.

22. A collecting device according to claim 17, wherein each chamber is indexed such that the system stores a record of which specific sample is within each chamber.

23. A collecting device according to claim 17, wherein each chamber further comprises agitation means for agitating the sample in the base thereof.

24. A collecting device according to claim 23, wherein the agitation means comprises sonification means.

25. A collecting device according to claim 23, wherein the agitation means comprises a magnetic stirrer.

26. A collecting device according to claim 17, the collecting device further comprising a depression valve for releasing one or more of the samples in use.
